(19) United States
(12) Patent Application Publication
(10) Pub. No.: US 2024/0300282 A1
(43) Pub. Date: Sep. 12, 2024

(54) AIR OUTLET STRUCTURE

(71) Applicant: HONDA MOTOR CO., LTD., Tokyo (JP)

(72) Inventors: Yu NAKASHIMA, Tokyo (JP); Daisuke KATO, Tochigi (JP)

(21) Appl. No.: 18/585,068

(22) Filed: Feb. 23, 2024

(30) Foreign Application Priority Data
Mar. 10, 2023 (CN) 202310226888.X

(51) Int. Cl. B60H 1/00

(52) U.S. Cl. CPC B60H 1/00028; B60H 1/00564; B60H 2001/00092

(57) ABSTRACT

Provided is an air outlet structure capable of adjusting an air flow direction in a plurality of directions by a simple configuration and reducing the pressure loss of air to be flowed. The air outlet structure 1 includes first fins 41 capable of adjusting an air flow direction in the width direction of the vehicle 100, a second fin 42 capable of adjusting the air flow direction in a vehicle width direction, an operator 5, a first linker 6 provided to connect the first fins 41 and the operator 5 to each other and moving the first fins 41 based on movement of the operator 5, and a second linker 7 provided to connect the second fin 42 and the operator 5 to each other and moving the second fin 42 based on movement of the operator 5. The operator 5 is provided outside an outlet port 3a.

This application is based on and claims the benefit of priority from Chinese Patent Application No. 202310226888 X, filed on 10 Mar. 2023, the content of which is incorporated herein by reference.

### BACKGROUND OF THE INVENTION

### Field of the Invention

The present invention relates to an air outlet structure.

### Related Art

There has been an air outlet structure capable of adjusting a direction (hereinafter referred to as an “air flow direction”) of blowing air through an outlet port up, down, right, and left

For example, an air outlet structure (register) of Japanese Unexamined Patent Application, Publication No. 2017-159876 includes a horizontally-long rectangular air outlet port, a rear fin arranged parallel with the lateral direction (up-down direction) of the air outlet port, and a front fin arranged parallel with the longitudinal direction (right-left direction) of the air outlet port. A slide member having a knob is fitted in the front fin. Thus, the front fin can be moved in such a manner that the knob is moved up and down. The slide member is slidable parallel with the longitudinal direction of the front fin. The rear fin and the slide member are connected to each other so that movement of the slide member can be transmitted to the rear fin. Thus, the rear fin can be moved in such a manner that the knob (slide member) is moved right and left. The air flow direction can be adjusted in the up-down direction and the right-left direction by one knob in this manner, and therefore, the configuration can be simplified.

Patent Document 1: Japanese Unexamined Patent Application, Publication No. 2017-159876

### SUMMARY OF THE INVENTION

However, the front fin has the knob and the slide member, and for this reason, is relatively thick. Thus, there have been concerns about the pressure loss of air to be flowed through the outlet port.

The present invention has been made in view of the above-described problems, and an object thereof is to provide an air outlet structure capable of adjusting an air flow direction in a plurality of directions by a simple configuration and reducing the pressure loss of air to be flowed.

(1) The present invention relates to an air outlet structure including a case fixed to a duct, the case being configured to supply air into a vehicle cabin of a vehicle, an air passage provided in the case and through which the air can pass, and an outlet port provided in the case and through which the air can be flowed into the vehicle cabin from the air passage. The air outlet structure is capable of adjusting an air flow direction which is a direction in which the air is flowed through the outlet port. A direction crossing a downstream direction which is a direction in which the air flows downstream in the air passage is defined as a first direction and a direction crossing the downstream direction and the first direction is defined as a second direction. The air outlet structure includes a first fin provided in the case and being capable of adjusting the air flow direction in the first direction, a second fin provided in the case and being capable of adjusting the air flow direction in the second direction, an operator formed so as to extend in the downstream direction and being capable of moving in the first direction and the second direction by user operation, a first linker provided to connect the first fin and the operator to each other and being capable of moving the first fin based on movement of the operator in the second direction, and a second linker provided to connect the second fin and the operator to each other and being capable of moving the second fin based on movement of the operator in the first direction. The operator is provided outside the outlet port in the first direction. The first linker has a first connector extending in the downstream direction and connected to the operator and a second connector extending in the first direction and connecting the first connector and the second fin to each other. The second linker has a third connector extending in the downstream direction and connecting the operator and the first fin to each other.

According to (1), the operator is provided outside the outlet port in the first direction. With this configuration, the pressure loss of the air to be flowed through the outlet port can be reduced. The first linker has the first connector extending in the downstream direction and the second connector extending in the first direction. The second linker has the third connector extending in the downstream direction. In this case, even in a case where the operator is arranged outside the outlet port in the first direction, the operator and the first fin can be coupled to each other by the first linker, and the operator and the second fin can be coupled to each other by the second linker.

Movement of the operator is transmitted to the first fin or the second fin through the first linker or the second linker. For example, a user can move the first fin by moving the operator in the first direction, and can move the second fin in the second direction by moving the operator in the second direction. As described above, adjustment of the air flow direction in the first direction and adjustment of the air flow direction in the second direction can be achieved by one operator, and therefore, the air flow direction can be adjusted in a plurality of directions by a simple configuration.

Thus, the air outlet structure can be provided, which can reduce the pressure loss of the air to be flowed while adjusting the air flow direction in the plurality of directions by the simple configuration.

(2) In the air outlet structure according to (1), at least one of the first linker or the second linker may be supported by the case.

According to (2), the operator is connected to the first linker and the second linker. At least one of the first linker or the second linker is supported by the case. With this configuration, occurrence of rattling due to movement of the operator can be reduced.

(3) In the air outlet structure according to (1) or (2), the first connector may have a first shaft having a first axis extending in the second direction as a center axis, a first end of the first shaft may be connected to the case such that the first connector is rotatable connector about the first axis, the third connector may have an insertion portion into which a second end of the first shaft is insertable, and the insertion portion is formed in a groove shape extending in the downstream direction.

(3) According to (3), the first linker (first connector) is connected to the case through the first shaft. The first linker and the second linker support each other through the first shaft. With this configuration, occurrence of rattling due to movement of the operator can be reduced.

(4) In the air outlet structure according to (3), the first connector may have the first shaft, and may be connected to the case through the first shaft. The third connector may have a second shaft having a second axis extending in the first direction as a center axis, and may be connected to the first connector through the second shaft so as to rotate about the second axis.

According to (4), the first connector (first linker) can rotate about the axis extending in the second direction. The third connector (second linker) can rotate about the axis extending in the first direction. The first shaft connecting the first connector and the case to each other and the second shaft connecting the second connector and the third connector to each other are provided such that directions in which these shafts extend are perpendicular to each other. With this configuration, a probability of the first connector limiting rotation of the third connector can be reduced.

(5) In the air outlet structure according to any one of (1) to (4), the operator may be rotatable about a third axis extending in the downstream direction. The air outlet structure may further include an adjustment valve provided in the case so as to be rotatable about a fourth axis extending in the first direction and capable of adjusting the volume of the air to be flowed through the outlet port, and a third linker provided to connect the adjustment valve and the operator to each other and being capable of moving the adjustment valve based on rotation movement of the operator about the third axis. The third linker may have a rod formed in a long shape extending in the downstream direction, configured to be rotatable about the third axis, and having a first end connected to the operator. The rod may have, at the first end thereof, a third shaft extending in a direction perpendicular to the longitudinal direction of the rod. The operator may have a fitting into which the third shaft fits.

According to (5), the adjustment valve can be moved in such a manner that the operator rotates about the third shaft. Thus, the air volume can also be adjusted in addition to adjustment of the air direction in the two directions by one operator 5, and therefore, a simpler configuration can be achieved.

Moreover, the third shaft is fitted in the fitting so that rotation of the operator can be suitably transmitted to the rod.

(6) In the air outlet structure according to (5), the first axis, the second axis, and the third axis may intersect each other at one point.

According to (6), the operator can rotate about the third axis independently of rotation of the second connector about the first axis and rotation of the third connector about the second axis.

(7) In the air outlet structure according to (5) or (6), the third linker may have a first bevel gear that is provided at a second end of the rod and is capable of rotating about the third axis together with the rod, and a second bevel gear that is provided at the adjustment valve and is capable of rotating about the fourth axis together with the adjustment valve and engaging with the first bevel gear.

According to (7), rotation movement of the operator and the rod about the third axis can be transmitted to the adjustment valve while the rotation direction is changed. Thus, the adjustment valve can be suitably operated in such a manner that the operator rotates about the third axis.

(8) In the air outlet structure according to any one of (5) to (7), the third connector may have a first member connected to the operator and a second member connected to the second fin, the first member may have a first surface which is a surface facing the second member, the second member may have a second surface which is a surface facing the first surface, a region of the first surface in the second direction and a region of the second surface in the second direction may be formed in shapes fittable with each other, and a region of the first surface in the first direction and a region of the second surface in the first direction may be formed as curved surfaces slidable on each other in a rotation direction about the first axis.

According to (8), both the first member and the second member can be moved in the second direction in such a manner that the operator is moved in the second direction. The first member can be moved in the first direction independently of the second member in such a manner that the operator is moved in the first direction.

According to the present invention, the air outlet structure can be provided, which is capable of adjusting the air flow direction in the plurality of directions by the simple configuration and reducing the pressure loss of the air to be flowed.

### BRIEF DESCRIPTION OF THE DRAWINGS

FIG. 1 is a view of an air outlet structure according to an embodiment of the present invention from the inside of a vehicle cabin;

FIG. 2 is a perspective view showing the air outlet structure according to the embodiment of the present invention;

FIG. 3 is a perspective view showing the air outlet structure according to the embodiment of the present invention in a disassembled state;

FIG. 4 is a perspective view showing the air outlet structure according to the embodiment of the present invention in the disassembled state;

FIG. 5 is a perspective view showing part of the air outlet structure according to the embodiment of the present invention in a disassembled state; and

FIG. 6 is a perspective view showing part of the air outlet structure according to the embodiment of the present invention in a disassembled state.

### DETAILED DESCRIPTION OF THE INVENTION

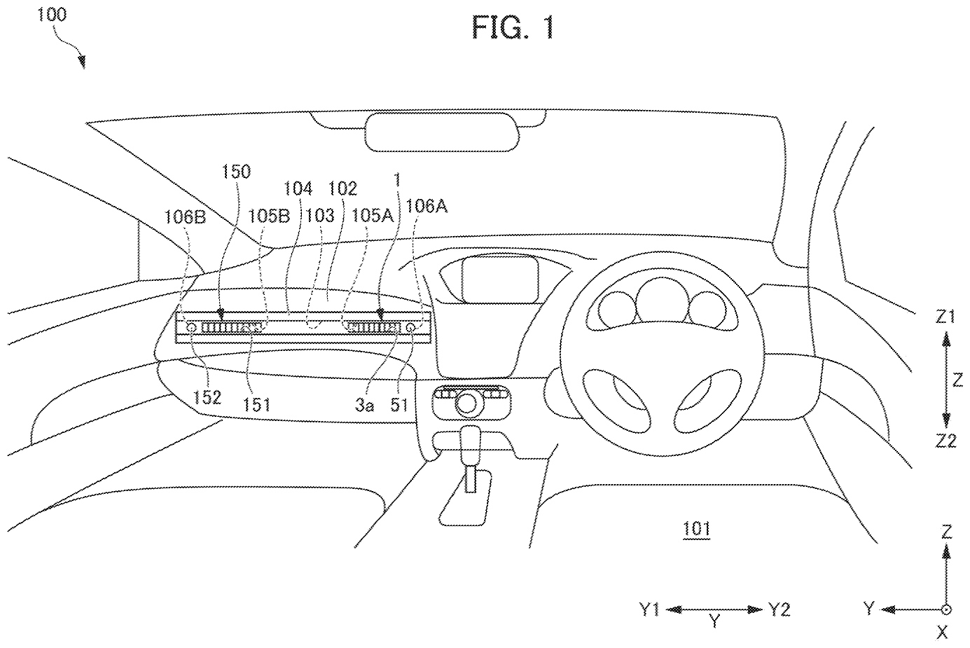

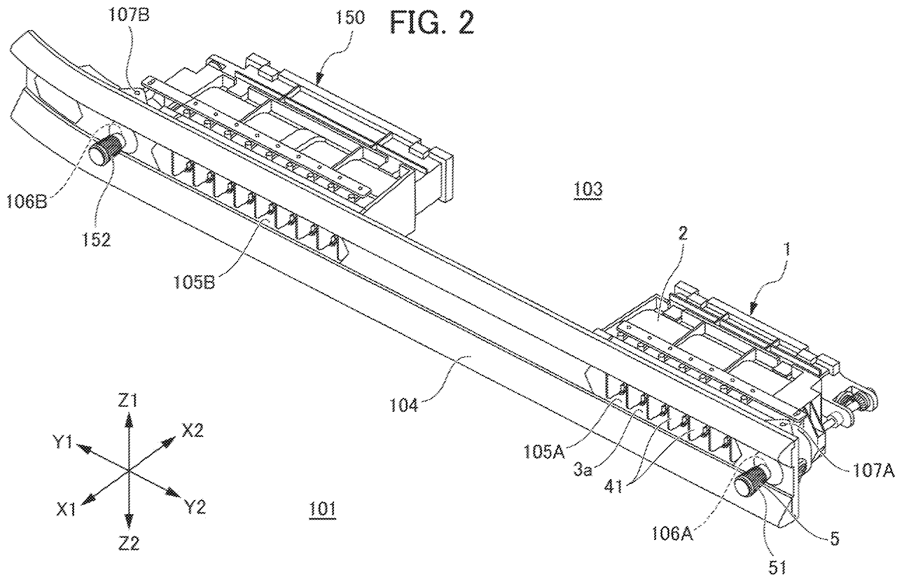

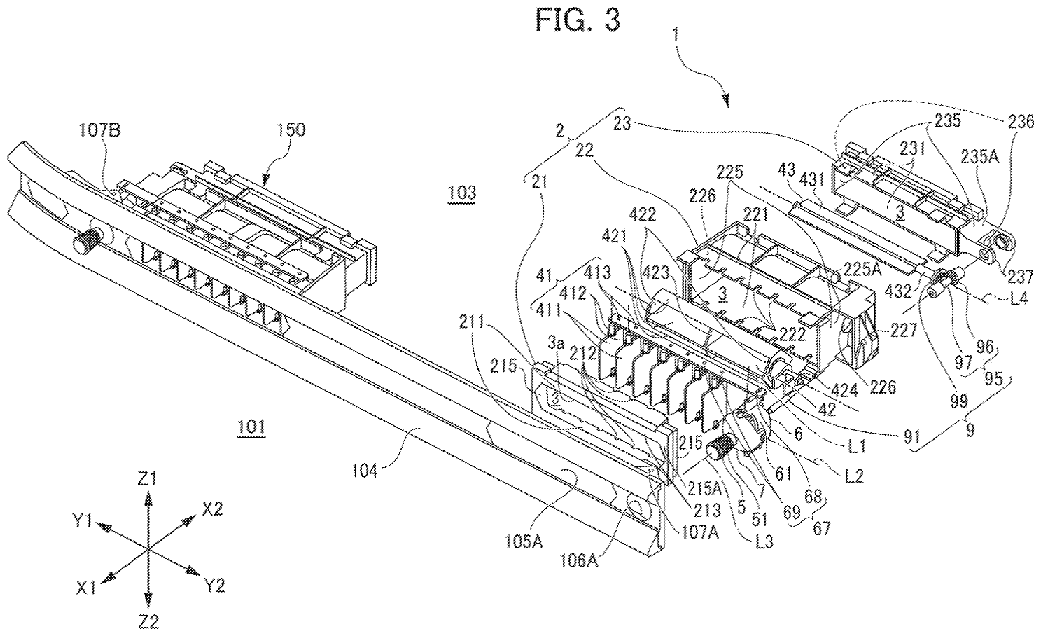

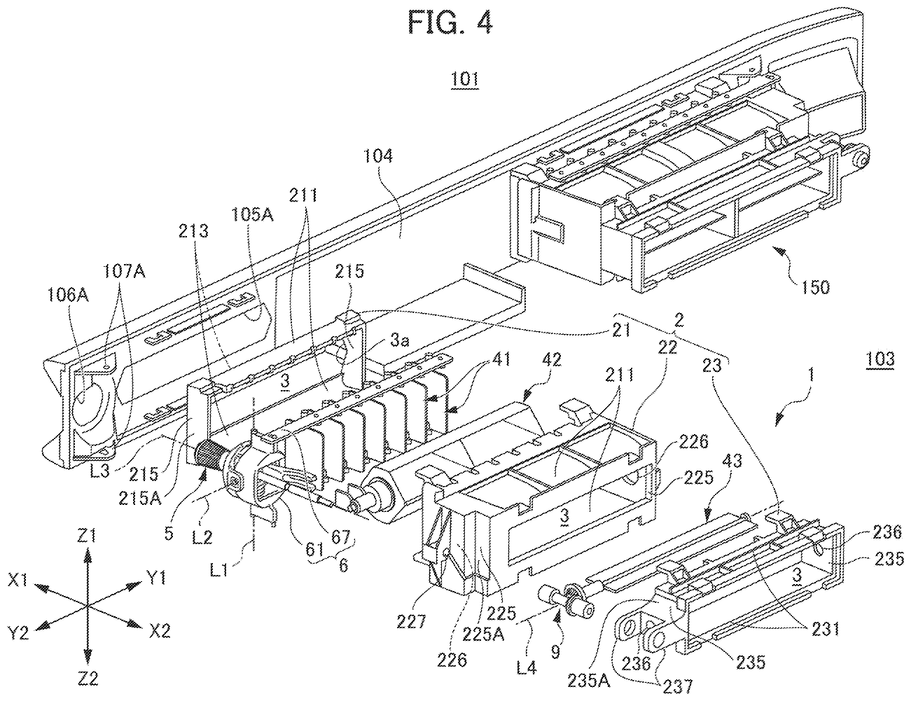

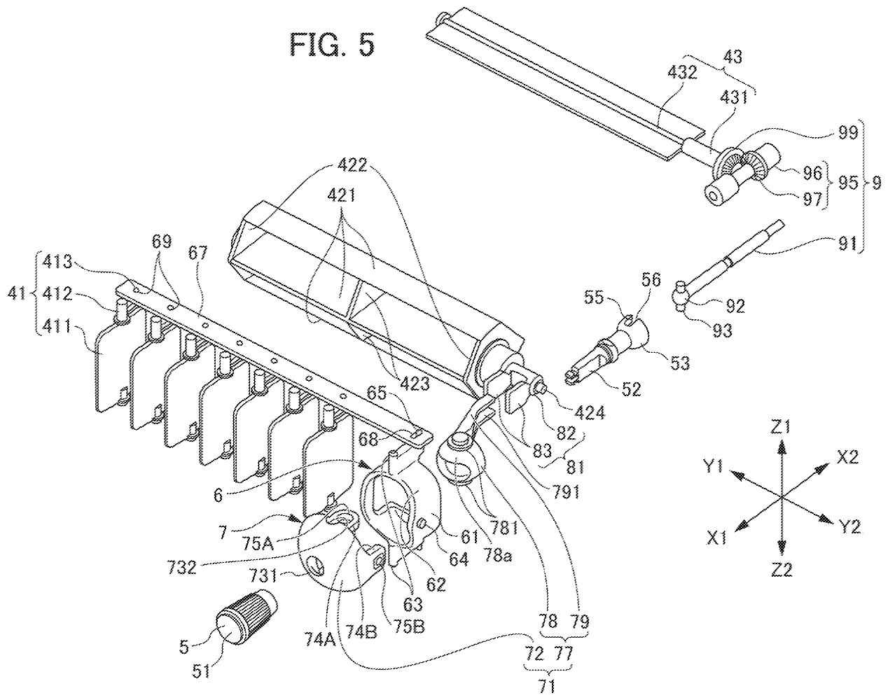

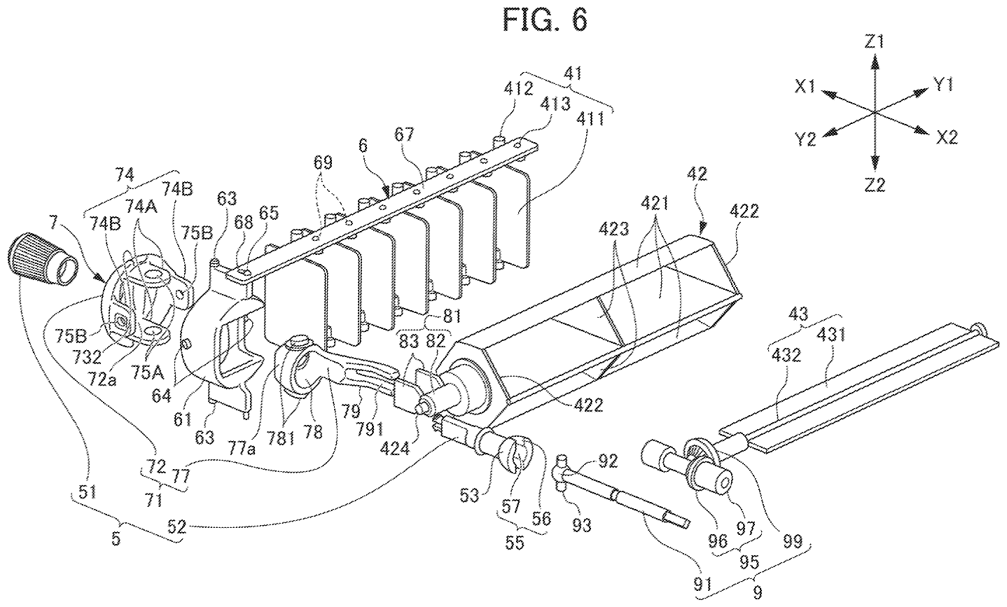

Hereinafter, an air outlet structure 1 according to an embodiment of the present invention will be described with reference to FIGS. 1 to 6. The air outlet structure 1 is provided in a vehicle 100 to supply air into a vehicle cabin 101. FIG. 1 is a view of the air outlet structure 1 from the inside of the vehicle cabin 101. FIG. 2 is a perspective view showing the air outlet structure 1. FIGS. 3 and 4 are perspective views showing the air outlet structure 1 in a disassembled state. FIG. 5 is a view showing part of the air outlet structure 1 in a disassembled state. Note that in FIGS. 2 to 4, a peripheral wall portion of a duct 103 is not shown for the sake of convenience. Moreover, FIGS. 1 to 4 also show an air outlet structure 150. The air outlet structure 1 and the air outlet structure 150 have configurations substantially similar to each other. Thus, the air outlet structure 1 will be basically described below as an example.

Note that in description below, an X-direction is the length direction of the vehicle 100, a Y-direction is the width direction of the vehicle 100, and a Z-direction is the height direction of the vehicle 100. Moreover, a rearward direction as viewed from a driver of the vehicle 100 is an X1-direction, and a forward direction as viewed from the driver is an X2-direction. A leftward direction as viewed from the driver is a Y1-direction, and a rightward direction as viewed from the driver is a Y2-direction. An upward direction as viewed from the driver is a Z1-direction, and a downward direction as viewed from the driver is a Z2-direction.

The air outlet structure 1 is provided in an orientation in which air flows downstream in the X-direction in an air passage 3 (described in detail later) of the air outlet structure 1. Thus, the X-direction is equivalent to a downstream direction in the claims. The Y-direction is equivalent to a first direction, and the Z-direction is equivalent to a second direction.

As shown in FIG. 1, the vehicle 100 includes the vehicle cabin 101, the duct 103 connecting an air-conditioning device (not shown) and the vehicle cabin 101 to each other, and each air outlet structure 1, 150. The air-conditioning device generates conditioned air.

An instrument panel 102 is provided in the vehicle cabin 101. The opening end of the duct 103 on the vehicle cabin 101 side opens in the instrument panel 102. The conditioned air generated by the air-conditioning device is supplied into the vehicle cabin 101 through the duct 103. Note that the conditioned air is equivalent to air in the claims.

The duct 103 has a duct lid 104 that covers the opening end of the duct 103 on the vehicle cabin 101 side. The duct lid 104 is in a rectangular shape. The duct lid 104 has two lid openings 105, two holes 106, and four protrusions 107 protruding from the duct lid 104 to the internal space side of the duct 103. Each lid opening 105 and each hole 106 penetrate the duct lid 104 in the thickness direction thereof.

Each lid opening 105 is formed as a rectangular opening, and is specifically formed as a rectangular opening long in the Y-direction. The lid openings 105 are arranged in the Y-direction. Of the lid openings 105, the lid opening 105 on the Y2-direction side is a lid opening 105A, and the lid opening 105 on the Y1-direction side is a lid opening 105B.

The holes 106 are provided with the lid openings 105 therebetween in the longitudinal direction of the lid opening 105, and are specifically arranged in the Y-direction. Of the holes 106, the hole 106 on the Y2-direction side is a hole 106A, and the hole 106 on the Y1-direction side is a hole 106B. The hole 106A is positioned on the Y2-direction side with respect to the lid opening 105A. The hole 106B is positioned on the Y1-direction side with respect to the lid opening 105B.

The air outlet structure 1 is provided in the lid opening 105A. The air outlet structure 150 is provided in the lid opening 105B.

Each protrusion 107 is substantially in a triangular plate shape, and has a hole penetrating the protrusion 107 in the plate thickness direction thereof. The protrusions 107 include a pair of protrusions 107A and a pair of protrusions 107B. The protrusions 107A are arranged in an orientation in which the plate surfaces thereof are parallel with each other with the hole 106A therebetween in the lateral direction of the lid opening 105A. A clearance dimension between the protrusions 107A is slightly greater than the dimension of the lid opening 105A in the lateral direction thereof. As in the protrusions 107A, the protrusions 107B are also arranged with the hole 106B therebetween.

The air outlet structure 1 includes a case 2, the air passage 3 in which the conditioned air passes, and an outlet port 3a through which the conditioned air is flowed into the vehicle cabin 101 from the air passage 3. Note that an air flow direction which is a direction of blowing the conditioned air through the outlet port 3a may be merely referred to as an “air flow direction” below.

The case 2 is in a box shape, specifically a rectangular parallelepiped box shape. The air passage 3 is provided so as to penetrate the case 2. The opening shape of the air passage 3 is substantially the same as the opening shape of the lid opening 105, specifically substantially a rectangular shape. The case 2 is fixed to the duct 103 so as to cover the lid opening 105 from the internal space side of the duct 103, and is specifically fixed to the duct lid 104.

The case 2 includes a first case body 21, a second case body 22, and a third case body 23. The first case body 21, the second case body 22, and the third case body 23 are formed in a tubular shape, specifically substantially a square tube shape. The first case body 21 is fixed to the duct lid 104. The first case body 21, the second case body 22, and the third case body 23 are provided in this order from the side close to the vehicle cabin 101, and adjacent ones of these bodies are coupled to each other. Note that in description below, the first case body 21, the second case body 22, and the third case body 23 may be collectively referred to as “each case body 21, 22, 23”.

The outlet port 3a is formed in the first case body 21. The conditioned air in the duct 103 flows downstream in the air passage 3, and is flowed into the vehicle cabin 101 through the outlet port 3a (lid opening 105). Specifically, the conditioned air flows downstream in the X-direction in the air passage 3, and is flowed through the outlet port 3a. The conditioned air is flowed to the driver or a passenger (hereinafter merely referred to as “e.g., the driver”) of the vehicle 100.

The first case body 21 includes a pair of outer wall portions 211 and a pair of outer wall portions 215 formed in a rectangular plate shape and forming the outer periphery of the first case body 21. When the first case body 21 is viewed from the outlet port 3a side, the outer wall portions 211 face each other in the lateral direction of the outlet port 3a, and the outer wall portions 215 face each other in the longitudinal direction of the outlet port 3a. Moreover, one of the outer wall portions 215 is an outer wall portion 215A

Each outer wall portion 211 has a plurality of holes 212 penetrating the outer wall portion 211 in the plate thickness direction thereof. The holes 212 are provided along the side of each outer wall portion 211 facing the second case body 22. The holes 212 formed in one of the outer wall portions 211 and the holes 212 formed in the other outer wall portion 211 are provided at corresponding positions in the direction in which the outer wall portions 211 face each other.

Each outer wall portion 215 is provided with an inclined portion 213. Each inclined portion 213 extends along a long-side portion of the outlet port 3a. One of the inclined portions 213 is inclined in a direction of approaching the other inclined portion 213 as extending from the second case body 22 side to the duct lid 104 side, and vice versa.

The second case body 22 has a pair of outer wall portions 221 and a pair of outer wall portions 225 formed in a rectangular plate shape and forming the outer periphery of the third case body 23.

Each outer wall portion 221 faces the outer wall portion 211 of the first case body 21. Each outer wall portion 221 has a plurality of holes 222. The holes 222 are provided at positions each corresponding to the holes 212 of the first case body 21.

Each outer wall portion 225 has a hole 226. Each hole 226 penetrates the outer wall portion 225 in the thickness direction thereof. Note that one of the outer wall portions 225 facing the outer wall portion 215A of the first case body 21 will be referred to as an “outer wall portion 225A”.

The third case body 23 has a pair of outer wall portions 231 and a pair of outer wall portions 235 formed in a rectangular plate shape and forming the outer periphery of the third case body 23.

Each outer wall portion 231 faces the outer wall portion 221 of the second case body 22. Each outer wall portion 235 faces the outer wall portion 225 of the second case body 22.

Each outer wall portion 235 has a hole 236, and each hole 236 penetrates the outer wall portion 235 in the thickness direction thereof. Note that one of the outer wall portions 235 facing the outer wall portion 225A of the second case body 22 will be referred to as an “outer wall portion 235A”.

The first case body 21 is fixed to the duct 103 in an orientation in which the outer wall portions 211 face each other in the Z-direction and the outer wall portions 215 face each other in the Y-direction. Specifically, the first case body 21 is fixed to the duct 103 such that the outer wall portion 215A faces the Y2-direction side.

The air outlet structure 1 includes a plurality of first fins 41 provided in the case 2 and capable of adjusting the air flow direction in the Y-direction, a second fin 42 provided in the case 2 and capable of adjusting the air flow direction in the Z-direction, and an adjustment valve 43 capable of adjusting the volume (hereinafter merely referred to as an “air flow volume”) of conditioned air to be flowed through the outlet port 3a.

Each first fin 41 has a rectangular plate-shaped first vane 411, a substantially circular columnar rotation shaft 412, and a substantially circular columnar protrusion 413.

Each rotation shaft 412 is provided, at a center portion of the first vane 411 in the lateral direction thereof, so as to penetrate the first vane 411 in an orientation in which the rotation shaft 412 is parallel with the longitudinal direction of the first vane 411.

Each protrusion 413 is provided, at one end portion of the first vane 411 in the lateral direction thereof, so as to protrude from the one end portion of the first vane 411 in the lateral direction thereof in an orientation in which the protrusion 413 is parallel with the longitudinal direction of the first vane 411.

Each first fin 41 is arranged in an orientation in which the center axis of the rotation shaft 412 is parallel with the Z-direction, and is specifically arranged in an orientation in which the protrusion 413 protrudes in the Y1-direction from the first vane 411 and is positioned at the end portion of the first fin 41 on the Z1-direction side. The end portions of each rotation shaft 412 in the longitudinal direction thereof are each inserted into the holes 212 of the first case body 21 and the holes 222 of the second case body 22. In this case, each first fin 41 is supported by the case 2. Each first fin 41 is rotatable about the center axis of the rotation shaft 412. Each first fin 41 rotates about the rotation shaft 412 so that the air flow direction can be adjusted in the Y-direction.

The second fin 42 has a plurality of second vanes 421 formed in a rectangular plate shape, a pair of end plates 422, two division plates 423, and a rotation shaft 424.

The second vanes 421 are provided such that the plate surfaces thereof are parallel with each other and long-side portions thereof are parallel with each other. The second vanes 421 are arranged in the plate thickness direction thereof.

The end plates 422 are provided with the second vanes 421 therebetween in the longitudinal direction of the second vane 421.

Each division plate 423 is provided such that the plate surface thereof is parallel with the plate surface of the end plate 422. Each division plate 423 is arranged at a center portion of the second vane 421 in the longitudinal direction thereof. Each division plate 423 connects adjacent ones of the second vanes 421 to each other. Each space between adjacent ones of the second vanes 421 is divided in the longitudinal direction of the second vane 421 by the division plate 423.

The rotation shaft 424 is provided on the outer surface of one of the end plates 422. The plate surface of the end plate 422 and the center axis of the rotation shaft 424 are perpendicular to each other.

The second fin 42 is arranged on the X2-direction side with respect to the first fins 41. The second fin 42 is arranged in an orientation in which the center axis of the rotation shaft 424 is parallel with the Y-direction. The rotation shaft 424 is inserted into the hole 226 of the second case body 22. The second fin 42 is supported by the case 2. The second fin 42 is rotatable about the center axis of the rotation shaft 424. The second fin 42 rotates about the center axis of the rotation shaft 424 so that the air flow direction can be adjusted in the Z-direction.

The adjustment valve 43 has a rectangular plate-shaped plate member 431 and a substantially circular columnar rotation shaft 432. The rotation shaft 432 extends along the longitudinal direction of the plate member 431, and at a center portion of the plate member 431 in the lateral direction thereof, penetrates the plate member 431 in the longitudinal direction of the plate member 431.

The adjustment valve 43 is arranged on the X2-direction side with respect to the second fin 42. The adjustment valve 43 is arranged in an orientation in which the center axis of the rotation shaft 432 is parallel with the Y-direction. The end portions of the rotation shaft 432 in the longitudinal direction thereof are each inserted into the holes 236 of the third case body 23. The adjustment valve 43 is supported by the case 2. The adjustment valve 43 is rotatable about the center axis of the rotation shaft 432.

The adjustment valve 43 can block the flow of conditioned air in the air passage 3 in a case where the plate surface of the plate member 431 is perpendicular to the X-direction. The adjustment valve 43 rotates about the center axis of the rotation shaft 432 so that the air flow volume can be adjusted. Note that the center axis of the rotation shaft 432 of the adjustment valve 43 will be referred to as a “fourth axis L4”. The fourth axis L4 extends parallel with the Y-direction.

The air outlet structure 1 described here includes an operator 5 to be operated by, e.g., the driver, a first link mechanism 6 connecting the operator 5 and the first fins 41 to each other, a second link mechanism 7 connecting the operator 5 and the second fin 42 to each other, and a third link mechanism 9 connecting the operator 5 and the adjustment valve 43 to each other.

First, the configuration of the operator 5 will be described.

The operator 5 has a knob 51 and a pin 52. The knob 51 is substantially in a cylindrical shape, and is operable with the first end side thereof pinched by, e.g., the driver. The pin 52 is formed in a rod shape. The first end of the pin 52 in the longitudinal direction thereof is connected to the second end of the knob 51. The knob 51 and the pin 52 integrally move. The pin 52 has a head 53 at the second end. The head 53 is substantially in a hemispherical shape, and a cut surface of the substantially hemispherical head 53 forms the second end of the pin 52. The diameter of the cut surface of the substantially hemispherical head 53 is greater than the thickness of the first end of the pin 52.

The pin 52 has a fitting portion 55 at the second end in the longitudinal direction of the pin 52. The fitting portion 55 extends, at the cut surface of the substantially hemispherical head 53, in the radial direction of such a cut surface. The fitting portion 55 has a slit 56 which is a slit extending in a direction perpendicular to the longitudinal direction of the pin 52 and a spherical recess 57 formed at a center portion of the slit 56 in the longitudinal direction thereof and recessed substantially in a hemispherical shape. A third shaft 93 and a spherical portion 92 of a rod member 91 described later can be fitted in the fitting portion 55. The third shaft 93 can be fitted in the slit 56, and the spherical portion 92 can be fitted in the spherical recess 57.

The operator 5 is arranged such that the longitudinal direction of the pin 52 is along an arrangement direction in which each case body 21, 22, 23 is arranged. The operator 5 is provided outside the outlet port 3a on the outer wall portion 215A side. With this configuration, the pressure loss of the air flowed through the outlet port 3a can be reduced.

Subsequently, arrangement of the operator 5 will be described.

The operator 5 is arranged in an orientation in which the longitudinal direction of the knob 51 and the longitudinal direction of the pin 52 are along the X-direction. Of the knob 51, the first end faces the X1-direction, and the second end faces the X2-direction. Of the pin 52, the first end faces the X1-direction, and the second end faces the X2-direction.

The operator 5 is arranged outside the outlet port 3a on the X2-direction side.

The operator 5 is inserted into the hole 106A of the duct lid 104. The first end side of the knob 51 is exposed in the vehicle cabin 101. Thus, e.g., the driver can operate the knob 51.

Although described in detail later, e.g., the driver can move the first end side of the knob 51 in the Y-direction and the Z-direction. Moreover, e.g., the driver can also turn/rotate the knob 51 about the center axis parallel with the longitudinal direction of the knob 51. Note that the center axis of the knob 51 will be referred to as a “third axis L3”. The third axis L3 extends parallel with the X-direction.

Subsequently, the configuration of the first link mechanism 6 will be described.

The first link mechanism 6 has a first connection member 61 and a second connection member 67.

The first connection member 61 has a body 62, two first shafts 63, two second shafts 64, and a protrusion 65.

The body 62 is formed substantially in a short cylindrical shape.

Each first shaft 63 is provided so as to protrude from the outer peripheral surface of the body 62. The first shafts 63 are provided with the body 62 therebetween, and the center axes of the first shafts 63 are positioned in the same straight line. Note that an axis including the center axes of the first shafts 63 will be referred to as a first axis L1.

Each second shaft 64 is provided so as to protrude from the outer peripheral surface of the body 62. The second shafts 64 are provided with the body 62 therebetween, and the center axes of the second shafts 64 are positioned in the same straight line. Note that an axis including the center axes of the second shafts 64 will be referred to as a second axis L2. The first axis L1 and the second axis L2 intersect each other at one point, and are specifically perpendicular to each other.

The protrusion 65 protrudes from the outer peripheral surface of the body 62. The protrusion 65 is substantially in a circular columnar shape, and the center axis thereof extends parallel with the first axis L1. The protrusion 65 is arranged next to one of the first shafts 63 in the center axis direction of the substantially cylindrical body 62.

The second connection member 67 is formed in a long plate shape. The second connection member 67 has a long hole 68 and a plurality of holes 69. Any of the long hole 68 and the holes 69 penetrates the second connection member 67 in the plate thickness direction thereof. The long hole 68 is provided in the first end of the second connection member 67 in the longitudinal direction thereof. The long hole 68 is formed in a long hole shape extending in the lateral direction of the second connection member 67.

Each hole 69 is provided in a region of the second connection member 67 on the second end side in the longitudinal direction of the second connection member 67 with respect to the long hole 68. The holes 69 are arranged along the longitudinal direction of the second connection member 67.

The protrusion 65 of the first connection member 61 is inserted into the long hole 68 of the second connection member 67. In this manner, the first connection member 61 and the second connection member 67 are connected to each other. The protrusion 65 is rotatable about the center axis of the protrusion 65 in the long hole 68. The protrusion 65 is slidable in the long hole 68 in a direction in which the long hole 68 extends.

Subsequently, arrangement of the first link mechanism 6 will be described.

The first connection member 61 is arranged in an orientation in which the first axis L1 extends parallel with the Z-direction, the second axis L2 extends in the Y-direction, the protrusion 65 protrudes in the Z1-direction, and the protrusion 65 is positioned on the X2-direction side with respect to the first shaft 63.

The first shafts 63 are each inserted into the holes of the protrusions 107A of the duct lid 104. With this configuration, the first link mechanism 6 (first connection member 61) is supported by the duct 103. Moreover, the first connection member 61 is rotatable about each first shaft 63 (first axis L1). Further, occurrence of rattling due to movement of the operator 5 can be reduced.

Note that each first shaft 63 is not necessarily connected to the duct 103, and may be connected to the case 2. In this case, occurrence of rattling due to movement of the operator 5 can also be reduced.

The second connection member 67 is arranged in an orientation in which the longitudinal direction thereof is parallel with the Y-direction. The second connection member 67 is arranged in an orientation in which the first end thereof faces the Y2-direction side and the second end thereof faces the Y1-direction side. The long hole 68 extends in the X2-direction. The protrusions 413 of the first fins 41 are each inserted into the holes 69 of the second connection member 67. With this configuration, the second connection member 67 (first link mechanism 6) is connected to each first fin 41.

Subsequently, the configuration of the second link mechanism 7 will be described.

The second link mechanism 7 has a third connection member 71 and a fourth connection member 81.

The third connection member 71 has a first member 72 and a second member 77.

The first member 72 has a substantially hemispherical body 73 and four plate members 74 formed in a flat plate shape.

The body 73 has a through-hole 731 penetrating the body 73 from the center of the spherical surface of the substantially hemispherical body 73 toward the center of the circular cut surface of the substantially hemispherical body 73 and two grooves 732 formed in the spherical surface of the substantially hemispherical body 73.

Each plate member 74 stands on the cut surface side of the body 73. The four plate members 74 include a pair of plate members 74A and a pair of plate members 74B. The plate members 74A are provided such that the plate surfaces thereof are parallel with each other. The plate members 74B are provided such that the plate surfaces thereof are parallel with each other. The plate surface of each plate member 74A is perpendicular to the plate surfaces of the plate members 74B, and vice versa. Each plate member 74 has a hole 75 penetrating the plate member 74 in the plate thickness direction thereof. The hole 75 of each plate member 74A will be referred to as a hole 75A, and the hole 75 of each plate member 74B will be referred to as a hole 75B. Note that each plate member 74A is arranged slightly apart from an outer peripheral edge portion of the cut surface of the substantially hemispherical body 73. Each plate member 74B is arranged along the outer peripheral edge portion of the cut surface of the substantially hemispherical body 73.

Each groove 732 extends with a predetermined length from the end portion of the substantially hemispherical body 73 on the cut surface side to the center of the spherical surface of the substantially hemispherical body 73. The grooves 732 face each other in the radial direction of the cut surface of the substantially hemispherical body 73, and face each other in an arrangement direction in which the plate members 74A are arranged. As viewed from the cut surface side of the substantially hemispherical body 73, a line connecting the grooves 732 to each other and a line connecting the holes 75A of the plate members 74A to each other are positioned in the same straight line.

The second member 77 has a short substantially-cylindrical head 78 and a long arm 79.

The head 78 has two shafts 781 protruding from the outer surface of the head 78. Each shaft 781 is in a short cylindrical shape. The shafts 781 are arranged with the head 78 therebetween in the radial direction of the substantially cylindrical head 78. The center axes of the shafts 781 are positioned in the same straight line.

The arm 79 extends in the center axis direction of the substantially cylindrical head 78. The arm 79 is provided such that the first end in the longitudinal direction thereof is connected to a peripheral wall portion of the substantially cylindrical head 78. As viewed in the center axis direction of the substantially cylindrical head 78, the arm 79 is provided at a position shifted 90 in the circumferential direction of the substantially cylindrical head 78 from each shaft 781.

The second end of the arm 79 in the longitudinal direction thereof is provided with a groove 791 extending in the longitudinal direction of the arm 79. The groove 791 penetrates the arm 79 in a direction perpendicular to the center axis of the shaft 781 of the head 78.

The outer diameter dimension of the substantially cylindrical head 78 smoothly decreases with an increase in a distance from the arm 79. Thus, a region, which is not provided with each shaft 781, of the outer peripheral surface of the head 78 is a spherical curved surface.

The fourth connection member 81 has a substantially cylindrical tubular portion 82 and two rectangular plate-shaped plate members 83.

Each plate member 83 stands on the outer peripheral surface of the tubular portion 82. The plate members 83 are arranged in the center axis direction of the substantially cylindrical tubular portion 82. The plate surfaces of the plate members 83 are parallel with each other.

The first member 72 and the second member 77 face each other. The first member 72 has, on the cut surface side of the substantially hemispherical body 73 thereof, a first surface 72a which is a surface facing the second member 77. Note that the plate surface of one of the plate members 74A facing the other plate member 74A and the plate surface of one of the plate members 74B facing the other plate member 74B form part of the first surface 72a. The second member 77 has, on the spherical surface side of the head 78, a second surface 77a which is a surface facing the first surface 72a. Note that the outer peripheral surface of each shaft 781 forms part of the second surface 77a.

The shafts 781 of the second member 77 are each inserted into the holes 75A of the first member 72. In other words, part of the first surface 72a and part of the second surface are in shapes fittable with each other. With this configuration, the second member 77 is connected to the first member 72. The first member 72 is rotatable about the center axis of each shaft 781.

A region of the second surface 77a other than a region corresponding to the plate surface of each plate member 74A is apart from the first surface 72a. With this configuration, a probability of the first member 72 limiting rotation of the second member 77 about each shaft 781 can be reduced.

Note that the first surface 72a and the second surface 77a may contact each other. In this case, the first surface 72a and the second surface 77a are formed as curved surfaces slidable on each other in the direction of rotation about the center axis of each shaft 781.

The second end of the arm 79 in the longitudinal direction thereof is sandwiched between the plate members 83 of the fourth connection member 81. Note that although not shown in the figure, a pin is provided between the plate members 83 and the arm 79 and the fourth connection member 81 can be connected to each other with the pin inserted into the long hole 68 of the arm 79.

Subsequently, arrangement of the second link mechanism 7 will be described.

The first member 72 is arranged on the X1-direction side with respect to the first connection member 61 in an orientation in which the cut surface of the substantially hemispherical first member 72 faces the first connection member 61, the plate members 74A face each other in the Z-direction, and the plate members 74B face each other in the Y-direction. A direction in which each groove 732 of the first member 72 extends is the X-direction.

The knob 51 is arranged on the X1-direction side with respect to the first member 72. The pin 52 is inserted into the through-hole 731 of the first member 72. The first end side of the pin 52 in the longitudinal direction thereof is connected to the knob 51. The second end (head 53) of the pin 52 in the longitudinal direction thereof is positioned on the X2-direction side with respect to the first member 72. That is, the first member 72 is sandwiched between the knob 51 and the head 53. With this configuration, the operator 5 is connected to the second link mechanism 7.

The second shafts 64 of the first connection member 61 are each inserted into the holes 75B of the first member 72. With this configuration, the first member 72 is connected to the first connection member 61. Thus, the second link mechanism 7 is connected to the first link mechanism 6. The second link mechanism 7 is supported by the case 2 through the first link mechanism 6. The first member 72 is rotatable about the center axes (second axis L2) of the second shafts 64.

The operator 5 is connected to the first link mechanism 6 through the first member 72 (second link mechanism 7).

Each plate member 74A of the first member 72 is arranged inside the substantially cylindrical body 62 of the first connection member 61. Each first shaft 63 of the first connection member 61 is adjacent to the groove 732 of the first member 72 on the X2-direction side.

The second member 77 is arranged in an orientation in which the longitudinal direction of the arm 79 is the X-direction and the center axis of each shaft 781 is parallel with the Z-direction. The second member 77 is inserted into the substantially cylindrical body 62 of the first connection member 61. The head 78 is positioned in the substantially cylindrical body 62 of the first connection member 61. The center axis of each shaft 781 of the second member 77 is positioned on the first axis L1. Note that the second end side (head 53) of the pin 52 is positioned inside the first member 72 and the head 78.

The fourth connection member 81 is arranged in an orientation in which the center axis of the substantially cylindrical tubular portion 82 thereof is parallel with the Y-direction, and is specifically arranged such that such a center axis is positioned on the fourth axis L4. The rotation shaft 424 of the second fin 42 is inserted into the tubular portion 82. With this configuration, the second link mechanism 7 and the second fin 42 are connected to each other. The tubular portion 82 and the second fin 42 are integrally rotatable about the fourth axis L4.

Subsequently, the configuration of the third link mechanism 9 will be described.

The third link mechanism 9 has the long circular columnar rod member 91, a first bevel gear 95, and a second bevel gear 99.

The rod member 91 has the spherical portion 92 in the spherical shape and the rod-shaped third shaft 93 extending in the direction perpendicular to the longitudinal direction of the rod member 91. The spherical portion 92 is provided at the first end of the rod member 91 in the longitudinal direction thereof. The third shaft 93 is provided at the first end of the rod member 91 in the longitudinal direction thereof, and is specifically provided so as to penetrate the spherical portion 92.

The first bevel gear 95 has a gear 96 which is a bevel gear and a rotation shaft 97. The rotation shaft 97 extends along the center axis of the gear 96, and penetrates the gear 96. The second end of the rod member 91 in the longitudinal direction thereof is connected to the rotation shaft 97. The center axis of the rotation shaft 97 and the center axis of the rod member 91 are positioned in a straight line. The rod member 91 and the first bevel gear 95 (rotation shaft 97) are integrally rotatable about the center axes thereof.

The second bevel gear 99 engages with the first bevel gear 95 (gear 96). The rotation direction of the first bevel gear 95 and the rotation direction of the second bevel gear 99 are different from each other by 90°.

Subsequently, arrangement of the third link mechanism 9 will be described.

The rod member 91 is arranged in an orientation in which the longitudinal direction thereof is parallel with the X-direction. The rod member 91 is provided such that the first end thereof faces the X1-direction and the second end thereof faces the X2-direction.

The first end of the rod member 91 is connected to the second end of the operator 5. The third shaft 93 and the spherical portion 92 are fitted in the fitting portion 55 of the pin 52. The third shaft 93 is fitted in the slit 56, and the spherical portion 92 is fitted in the spherical recess 57. With this configuration, the third link mechanism 9 and the operator 5 are connected to each other. Note that the center axis (third axis L3) of the operator 5 and the center axis of the rod member 91 are positioned in the same straight line.

The depth of the slit 56 is set greater than the thickness of the third shaft 93. In this case, there is play between the slit 56 and the third shaft 93 in the X2-direction.

The spherical portion 92 and the third shaft 93 are positioned inside the body 62 of the first connection member 61 and the head 78 of the second member 77. The first axis L1, the second axis L2, and the center axis (third axis L3) of the rod member 91 intersect each other at one point. Note that the point of intersection between the first axis L1, the second axis L2, and the third axis L3 is coincident with the center of the spherical portion 92.

The outer wall portion 225A of the second case body 22 has a bearing portion 227 in the outer surface. The bearing portion 227 is provided in the outer surface of the second case body 22 on the Y2-direction side. The bearing portion 227 is provided such that the center axis thereof is positioned on the third axis L3.

The rod member 91 is inserted into the bearing portion 227. The rod member 91 is supported by the bearing portion 227 so as to rotate about the third axis L3.

The first bevel gear 95 is arranged in an orientation in which the center axis of the rotation shaft 97 thereof is parallel with the X-direction. The center axis of the rotation shaft 97 is positioned on the third axis L3.

The outer wall portion 235A of the third case body 23 has two bearing portions 237 in the outer surface. Each bearing portion 237 is provided in the outer surface of the third case body 23 on the Y2-direction side. Each bearing portion 237 is provided such that the center axis thereof is positioned on the third axis L3.

The end portions of the rotation shaft 97 of the first bevel gear 95 in the longitudinal direction thereof are each inserted into the bearing portions 237. The first bevel gear 95 is supported by each bearing portion 237 so as to rotate about the third axis L3.

The second bevel gear 99 is arranged in an orientation in which the center axis thereof is parallel with the Y-direction. The center axis of the second bevel gear 99 is positioned on the fourth axis L4. The first bevel gear 95 and the second bevel gear 99 engage with each other.

The second bevel gear 99 is connected to the rotation shaft 432 of the adjustment valve 43, and is specifically connected to the end portion of the rotation shaft 432 on the Y2-direction side. The second bevel gear 99 is rotatable integrally with the adjustment valve 43 about the fourth axis L4. With this configuration, the third link mechanism 9 and the adjustment valve 43 are connected to each other.

Interlocking movement of the operator 5, the first link mechanism 6, and the first fins 41 will be described.

When, e.g., the driver moves the first end side of the knob 51 in the Y-direction, the operator 5 rotates about the first axis L1. The first end side of the operator 5 moves in the Y-direction so as to draw an arc about the second end side of the operator 5. Specifically, the operator 5 rotates in the Y2-direction about the point of intersection between the center axis of the rod member 91, the first axis L1, and the second axis L2. At this time, the operator 5 and the first member 72 of the second link mechanism 7 integrally rotates about the first axis L1.

Rotation of the second member 77 of the second link mechanism 7 about the first axis L1 is limited by the second fin 42 and the fourth connection member 81. However, the first surface 72a of the first member 72 and the second surface 77a of the second member 77 are apart from each other, and therefore, the first member 72 can rotate about the first axis L1 independently of the second member 77.

The first member 72 of the third connection member 71 and the body 62 of the first connection member 61 integrally rotate about the first axis L1. The protrusion 65 of the first connection member 61 moves in the Y-direction so as to draw an arc about the first axis L1.

The second connection member 67 moves in the Y-direction along with movement of the protrusion 65 in the Y-direction. At this time, the protrusion 65 also slightly moves in the X2-direction. However, the long hole 68 of the second connection member 67 is formed in the long hole shape extending in the X-direction, and the protrusion 65 is slidable in the long hole 68. Thus, the second connection member 67 can smoothly move in the Y-direction.

Subsequently, the protrusion 413 of each first fin 41 moves in the Y-direction along with movement of the second connection member 67 in the Y-direction.

Subsequently, each first fin 41 rotates about the rotation shaft 412 along with movement of the protrusion 413 in the Y-direction.

As described above, the first fins 41 can be moved in such a manner that the first end of the operator 5 (knob 51) is moved in the Y-direction. With this configuration, the air flow direction can be adjusted in the Y-direction.

Subsequently, interlocking movement of the operator 5, the second link mechanism 7, and the second fin 42 will be described.

When, e.g., the driver moves the first end side of the knob 51 in the Z-direction, the operator 5 rotates about the second axis L2. The first end side of the operator 5 moves in the Z-direction so as to draw an arc about the second end side of the operator 5.

The operator 5 and the first member 72 integrally rotates about the second axis L2. The first member 72 and the second member 77 integrally rotate about the second axis L2.

The first member 72 of the third connection member 71 and the body 62 of the first connection member 61 are connected to each other through each second shaft 64. Thus, the first member 72 can rotate about the second shafts 64 (second axis L2) independently of the body 62.

Along with rotation of the body 62 about the second axis L2, each first shaft 63 of the body 62 enters the groove 732 of the first member 72, and slides in the X-direction in the groove 732. With this configuration, a probability of the first member 72 limiting rotation of the body 62 about the second axis L2 can be reduced. Note that each groove 732 is equivalent to an insertion portion in the claims.

In the region where the first member 72 (first surface 72a) and the second member 77 (second surface 77a) face each other in the Z-direction, each shaft 781 is fitted in the hole 75A. With this configuration, slide of the first surface 72a and the second surface 77a in the Z-direction can be reduced, and therefore, the first member 72 and the second member 77 can integrally rotate about the second axis L2.

When the second member 77 rotates about the second axis L2, the end portion of the arm 79 of the second member 77 on the X2-direction side moves in the Z2-direction. When the end portion of the arm 79 on the X2-direction side moves in the Z-direction, the end portion of the fourth connection member 81 on the X1-direction side moves in the Z2-direction. At this time, the end portion of the arm 79 on the X2-direction side also slightly moves in the X2-direction. However, the connection portion (e.g., pin) between the arm 79 and the fourth connection member 81 is slidable in the long hole 68, and therefore, the fourth connection member 81 can smoothly move along with movement of the arm 79.

Subsequently, when the end portion of the fourth connection member 81 on the arm 79 side moves in the X-direction, the tubular portion 82 of the fourth connection member 81 rotates about the fourth axis L4. Then, the second fin 42 rotates integrally with the tubular portion 82 about the fourth axis L4.

As described above, the second fin 42 can be moved in such a manner that the first end of the operator 5 (knob 51) is moved in the Z-direction. With this configuration, the air flow direction can be adjusted in the Z-direction. The air flow direction can be adjusted in two directions by one operator 5 as described above.

Note that in a case where the end portion of the knob 51 on the X1-direction side is moved in the Z1-direction, the end portion of the arm 79 on the X2-direction side moves in the Z2-direction. The end portion of the fourth connection member 81 on the X1-direction side moves in the Z2-direction, and rotates about the fourth axis L4. The second fin 42 rotates about the fourth axis L4 in a direction of the end portion thereof on the X1-direction side moving in the Z2-direction. In this case, the second fin 42 adjusts the conditioned air direction in the Z2-direction. Then, in the outlet port 3a, the conditioned air contacts the Y2-direction-side inclined portion 213 of the inclined portions 213, and changes its direction to the Z1-direction. Thus, the conditioned air flow direction can be adjusted to the Z1-direction in such a manner that the end portion of the knob 51 on the X1-direction side is moved in the Z1-direction.

Moreover, the conditioned air flow direction can be adjusted to the Z2-direction in such a manner that the end portion of the knob 51 on the X1-direction side is moved in the Z2-direction. As described above, when the air flow direction is adjusted in the Z-direction, the movement direction of the knob 51 and the air flow direction can be coincident with each other, and therefore, the air flow direction can be easily adjusted.

There is the play in the X2-direction between the slit 56 of the operator 5 and the third shaft 93 of the rod member 91. When the operator 5 is moved in a direction in which the third shaft 93 extends, the third shaft 93 slides in the slit 56. With this configuration, the operator 5 can move in the direction in which the third shaft 93 extends independently of the rod member 91. Moreover, the operator 5 can rotate about the center axis of the third shaft 93. Thus, the operator 5 can move in the direction perpendicular to the direction in which the third shaft 93 extends independently of the rod member 91. The operator 5 can move in the Y-direction and the Z-direction independently of the rod member 91 as described above.

Subsequently, interlocking movement of the operator 5, the third link mechanism 9, and the adjustment valve 43 will be described.

When, e.g., the driver rotates the knob 51 about the third axis L3, the operator 5 and the rod member 91 integrally rotate about the third axis L3. The rod member 91 has the third shaft 93 extending in the direction perpendicular to the longitudinal direction of the rod member 91, and the third shaft 93 is fitted in the fitting portion 55 (slit 56) of the operator 5. Thus, rotation of the operator 5 is suitably transmitted to the rod member 91.

The first axis L1, the second axis L2, and the center axis (third axis L3) of the rod member 91 intersect each other at one point. With this configuration, the operator 5 can rotate about the third axis L3 independently of rotation of the second connection member 67 about the first axis L1 and rotation of the third connection member 71 about the second axis L2.

When the rod member 91 rotates about the third axis L3, the first bevel gear 95 rotates about the third axis L3. Rotation of the first bevel gear 95 is transmitted to the second bevel gear 99. The second bevel gear 99 rotates about the fourth axis L4. When the second bevel gear 99 rotates, the adjustment valve 43 rotates about the fourth axis L4. As described above, by the first bevel gear 95 and the second bevel gear 99, rotation of the operator 5 (rod member 91) about the third axis L3 can be transmitted to the adjustment valve 43 while the rotation direction is changed.

As described above, the adjustment valve 43 can be moved in such a manner that the operator 5 (knob 51) rotates about the third axis L3. With this configuration, the air flow volume can be adjusted. As described above, by one operator 5, the air flow volume can also be adjusted in addition to adjustment of the air flow direction in the two directions.

Note that the air outlet structure 150 has a positional relationship of various components inverted from that of the air outlet structure 1 in the Y-direction. The air outlet structure 150 includes an outlet port 151 and an operator 152. The operator 152 is positioned outside the outlet port 151 in the Y1-direction. The operator may be positioned outside the outlet port in the Y1-direction or outside the outlet port in the Y2-direction.

According to the air outlet structure 1 of the present embodiment, the following advantageous effects are obtained.

(1) According to the present embodiment, the operator 5 is arranged outside the outlet port 3a in the Y-direction (width direction of the vehicle 100). With this configuration, the pressure loss of the air flowed through the outlet port 3a can be reduced. The first link mechanism 6 has the first connection member 61 extending in the X-direction (direction equivalent to the downstream direction, length direction of the vehicle 100) and the second connection member 67 extending in the Y-direction (width direction of the vehicle 100). The second link mechanism 7 has the third connection member 71 extending in the X-direction. In this case, even when the operator 5 is arranged outside the outlet port 3a in the Y-direction, the operator 5 and the first fins 41 can be coupled to each other by the first link mechanism 6 and the operator 5 and the second fin 42 can be coupled to each other by the second link mechanism 7.

According to the present embodiment, the first link mechanism 6 is provided to connect the first fins 41 and the operator 5 to each other and is capable of moving the first fins 41 based on movement of the operator 5 in the two directions and the second link mechanism 7 is provided to connect the second fin 42 and the operator 5 to each other and is capable of moving the second fin 42 based on movement of the operator 5 in the Y-direction. With this configuration, movement of the operator 5 is transmitted to the first fins 41 or the second fin 42 through the first link mechanism 6 or the second link mechanism 7. For example, a user can move the first fins 41 by moving the operator 5 in the Y-direction, and can move the second fin 42 in the Z-direction by moving the operator 5 in the Z-direction. As described above, adjustment of the air flow direction in the Y-direction and adjustment of the air flow direction in the Z-direction can be achieved by one operator 5, and therefore, the air flow direction can be adjusted in a plurality of directions by a simple configuration.

Thus, according to the present embodiment, the air outlet structure can be provided, which can reduce the pressure loss of the air to be flowed while adjusting the air flow direction in the plurality of directions by the simple configuration.

(2) According to the present embodiment, the operator 5 is connected to the first link mechanism 6 and the second link mechanism 7. At least one of the first link mechanism 6 or the second link mechanism 7 is supported by the case. With this configuration, occurrence of rattling due to movement of the operator 5 can be reduced.

(3) According to the present embodiment, the first link mechanism 6 (first connection member 61) is connected to the case through the first shafts 63. The first link mechanism 6 and the second link mechanism 7 support each other through the first shafts. With this configuration, occurrence of rattling due to movement of the operator 5 can be reduced.

(4) According to the present embodiment, the first connection member 61 is connected to the case 2 through the first shafts 63. The third connection member 71 is connected to the first connection member 61 through the second shafts 64 so as to be rotatable about the second axis L2. With this configuration, the first connection member 61 (first link mechanism 6) can rotate about the axis extending in the Z-direction. The third connection member 71 (second link mechanism 7) can rotate about the axis extending in the Y-direction. The first shafts 63 connecting the second connection member 67 and the case to each other and the second shafts 64 connecting the second connection member 67 and the third connection member 71 to each other are provided such that directions in which these shafts extend are perpendicular to each other. With this configuration, a probability of the second connection member 67 limiting rotation of the third connection member 71 can be reduced.

(5) According to the present embodiment, the operator 5 can rotate about the third axis L3 extending in the X-direction. The air outlet structure 1 includes the adjustment valve 43 that is provided so as to be rotatable about the fourth axis L4 extending in the Y-direction in the case 2 and is capable of adjusting the volume of air to be flowed through the outlet port 3a. The air outlet structure 1 includes the third link mechanism 9 that is provided to connect the adjustment valve 43 and the operator 5 to each other and is capable of moving the adjustment valve 43 based on rotation movement of the operator 5 about the third axis L3. The third link mechanism 9 has the rod member 91 formed in the long shape extending in the X-direction, configured to be rotatable about the third axis, and having the first end connected to the operator 5. The rod member 91 has, at the first end thereof, the third shaft 93 extending in the direction perpendicular to the longitudinal direction of the rod member 91. The operator 5 has the fitting portion in which the third shaft 93 is to be fitted. With this configuration, the adjustment valve can be moved in such a manner that the operator 5 rotates about the third shaft 93. Thus, the air volume can also be adjusted in addition to adjustment of the air direction in the two directions by one operator 5, and therefore, a simpler configuration can be achieved.

According to the present embodiment, the third shaft 93 extending in the direction perpendicular to the longitudinal direction of the rod member 91 is fitted in the fitting portion. With this configuration, rotation of the operator 5 can be suitably transmitted to the rod member 91.

(6) According to the present embodiment, the first axis L1, the second axis L2, and the third axis L3 intersect each other at one point. With this configuration, the operator 5 can rotate about the third axis L3 independently of rotation of the second connection member 67 about the first axis L1 and rotation of the third connection member 71 about the second axis L2.

(7) According to the present embodiment, the third link mechanism 9 has the first bevel gear 95 provided at the second end of the rod member 91 and is capable of rotating about the third axis together with the rod member 91. The third link mechanism 9 has the second bevel gear 99 provided at the adjustment valve 43, and is capable of rotating about the fourth axis L4 together with the adjustment valve 43 and engaging with the first bevel gear 95. With this configuration, rotation movement of the operator 5 and the rod member 91 about the third axis L3 can be transmitted to the adjustment valve while the rotation direction is changed. Thus, the adjustment valve can be suitably operated in such a manner that the operator 5 rotates about the third axis L3.

(8) According to the present embodiment, the third connection member 71 has the first member 72 connected to the operator 5 and the second member 77 connected to the second fin 42. The first member 72 has the first surface 72a which is the surface facing the second member 77. The second member 77 has the second surface 77a which is the surface facing the first surface 72a. The regions of the first surface 72a in the Z-direction and the regions of the second surface 77a in the Z-direction are formed in shapes fittable with each other. The regions of the first surface 72a in the Y-direction and the regions of the second surface 77a in the Y-direction are formed as curved surfaces slidable on each other in the rotation direction about the first axis L1. With this configuration, both the first member 72 and the second member 77 can be moved in the Z-direction in such a manner that the operator 5 is moved in the Z-direction. The first member 72 can be moved in the Y-direction independently of the second member 77 in such a manner that the operator 5 is moved in the Y-direction.

The preferred embodiment of the present invention has been described above, but the present invention is not limited to the above-described embodiment and changes can be made as necessary.

In the above-described embodiment, the downstream direction is the X-direction, but the present invention is not limited thereto. For example, the downstream direction may be the Y-direction or the Z-direction. In these cases, the air outlet structure can suitably blow air to the driver or the passenger from the side or above.

In the above-described embodiment, the air outlet structure 1 is arranged in an orientation in which the first fins 41 adjust the air flow direction in the Z-direction and the second fin 42 adjusts the air flow direction in the Y-direction, but the orientation in which the air outlet structure is arranged is not limited thereto. The air outlet structure may be arranged, for example, in an orientation in which the first fins adjust the air flow direction in the Y-direction and the second fin adjusts the air flow direction in the Z-direction. In this case, the Z-direction is equivalent to the first direction, and the Y-direction is equivalent to the second direction. The directions in which the air flow direction is adjusted by the first fins and the second fin are not necessarily the directions parallel with the Y-direction and the Z-direction. The air outlet structure may be arranged in an orientation in which the directions in which the air flow direction is adjusted by the first fins and the second fin are directions diagonal to the horizontal plane.

In the above-described embodiment, the air outlet structure 1 supplies the conditioned air generated by the air-conditioning device into the vehicle cabin 101, but the present invention is not limited thereto. The air outlet structure may directly supply air outside or inside the vehicle into the vehicle cabin, for example. That is, the air to be supplied into the vehicle cabin by the air outlet structure is not limited to the conditioned air.

### EXPLANATION OF REFERENCE NUMERALS

1, 150 Air outlet structure
3 Air Passage
3a, 151 Outlet port
5, 152 Operator
6 First Link Mechanism
7 Second Link Mechanism
9 Third Link Mechanism
41 First Fin
42 Second Fin
43 Adjustment Valve
55 Fitting Portion
61 First Connection Member
63 First Shaft
64 Second Shaft
67 Second Connection Member
71 Third Connection Member
72 First Member
72a First Surface
77 Second Member
77a Second Surface
91 Rod Member
93 Third shaft
95 First Bevel Gear
99 Second Bevel Gear
100 Vehicle
101 Vehicle Cabin
103 Duct
732 Groove (Insertion Portion)

What is claimed is:

1. An air outlet structure including
a case fixed to a duct, the case being configured to supply air into a vehicle cabin of a vehicle,
an air passage provided in the case and through which the air can pass, and
an outlet port provided in the case and through which the air can be flowed into the vehicle cabin from the air passage, the air outlet structure being capable of adjusting an air flow direction which is a direction in which the air is flowed through the outlet port, and
when a direction crossing a downstream direction which is a direction in which the air flows downstream in the air passage is defined as a first direction and a direction crossing the downstream direction and the first direction is defined as a second direction, the air outlet structure comprising:
a first fin provided in the case and being capable of adjusting the air flow direction in the first direction;
a second fin provided in the case and being capable of adjusting the air flow direction in the second direction;
an operator formed so as to extend in the downstream direction and being capable of moving in the first direction and the second direction by user operation;
a first linker provided to connect the first fin and the operator to each other and being capable of moving the first fin based on movement of the operator in the second direction; and
a second linker provided to connect the second fin and the operator to each other and being capable of moving the second fin based on movement of the operator in the first direction,
wherein the operator is provided outside the outlet port in the first direction,
the first linker has a first connector extending in the downstream direction and connected to the operator and a second connector extending in the first direction and connecting the first connector and the second fin to each other, and
the second linker has a third connector extending in the downstream direction and connecting the operator and the first fin to each other.

2. The air outlet structure according to claim 1, wherein at least one of the first linker or the second linker is supported by the case.

3. The air outlet structure according to claim 1, wherein
the first connector has a first shaft having a first axis extending in the second direction as a center axis,
a first end of the first shaft is connected to the case such that the first connector is rotatable about the first axis,
the third connector has an insertion portion into which a second end of the first shaft is insertable, and
the insertion portion is formed in a groove shape extending in the downstream direction.

4. The air outlet structure according to claim 3, wherein
the first connector has the first shaft, and is connected to the case through the first shaft, and
the third connector has a second shaft having a second axis extending in the first direction as a center axis, and is connected to the first connector through the second shaft so as to be rotatable about the second axis.

5. The air outlet structure according to claim 4,
the operator being rotatable about a third axis extending in the downstream direction, the air outlet structure further comprising:
an adjustment valve provided in the case so as to be rotatable about a fourth axis extending in the first direction and being capable of adjusting a volume of the air to be flowed through the outlet port; and
a third linker provided to connect the adjustment valve and the operator to each other and being capable of moving the adjustment valve based on rotation movement of the operator about the third axis,
wherein the third linker has a rod formed in a long shape extending in the downstream direction, configured to be rotatable about the third axis, and having a first end connected to the operator,
the rod has, at the first end thereof, a third shaft extending in a direction perpendicular to a longitudinal direction of the rod, and
the operator has a fitting into which the third shaft fits.

6. The air outlet structure according to claim 5, wherein the first axis, the second axis, and the third axis intersect each other at one point.

7. The air outlet structure according to claim 5, wherein the third linker has a first bevel gear that is provided at a second end of the rod and is capable of rotating about the third axis together with the rod, and a second bevel gear that is provided at the adjustment valve and is capable of rotating about the fourth axis together with the adjustment valve and engaging with the first bevel gear.

8. The air outlet structure according to claim 5, wherein
the third connector has a first member connected to the operator and a second member connected to the second fin,
the first member has a first surface which is a surface facing the second member,
the second member has a second surface which is a surface facing the first surface,
a region of the first surface in the second direction and a region of the second surface in the second direction are formed in shapes fittable with each other, and
a region of the first surface in the first direction and a region of the second surface in the first direction are formed as curved surfaces slidable on each other in a rotation direction about the first axis.
